(19) United States
(12) Patent Application Publication
(10) Pub. No.: US 2018/0300315 A1
(43) Pub. Date: Oct. 18, 2018

(54) SYSTEMS AND METHODS FOR DOCUMENT PROCESSING USING MACHINE LEARNING

(71) Applicant: Novabase Business Solutions, S.A., Lisboa (PT)

(72) Inventors: João Leal, Aveiro (PT); Maria de Fátima Machado Dias, Capeludos de Aguiar (PT); Sara Pinto, Oliveirinha (PT); Pedro Verruma, Coimbra (PT); Bruno Antunes, Coimbra (PT); Paulo Gomes, Coimbra (PT)

(21) Appl. No.: 15/950,537

(22) Filed: Apr. 11, 2018

Related U.S. Application Data
(60) Provisional application No. 62/485,428, filed on Apr. 14, 2017.

(51) Int. Cl. G06F 17/27; G06F 17/30; G06N 3/08

(52) U.S. Cl. CPC G06F 17/2785; G06F 17/30011; G06F 17/2735; G06F 17/2705; G06F 17/277; G06N 3/08

(57) ABSTRACT

Disclosed herein are embodiments of systems, devices, and methods automated document analysis and processing using machine learning techniques. In one embodiment, systems and methods are disclosed for automatically classifying documents. In another embodiment, systems and methods are disclosed for identifying new tags for untagged documents. In another embodiment, systems and methods are disclosed for identifying documents related to a target document.

### CROSS-REFERENCE TO RELATED APPLICATIONS

The present application claims priority to U.S. Provisional Patent No. 62/485,428 [Atty. Dkt. No. 172845-010200] filed on Apr. 14, 2017 and entitled “SYSTEMS AND METHODS FOR DOCUMENT PROCESSING USING MACHINE LEARNING,” the contents of which are incorporated by reference in its entirety.

### BACKGROUND

### Technical Field

Embodiments disclosed herein relate to the field of machine learning and natural language processing, and, specifically, to the field of automated electronic document processing and classification using machine learning systems.

### Description of the Related Art

Current techniques for classifying documents generally rely on comparing unknown documents to a corpus of known documents and/or a set of tags associated with documents. For example, current techniques may inspect a document to determine if the exact tags appear within the document. These techniques are inherently limited as they rely on the content of documents being similar or rely on tags themselves being within a document. In a similar vein, current techniques for suggesting tags for documents utilize simplistic measures for identifying commonly occurring words within a document (i.e., word counts). These techniques are necessarily limited in that they can only recommend material appearing within a document itself. Finally, current techniques for identifying documents similar to a target document generally involve browsing for documents in a predefined indexing structure, searching for keywords or tags in a set of documents, or by being suggested documents automatically. Current techniques for suggesting documents generally involve identifying documents similar to a document being viewed.

The current techniques suffer from the same drawbacks, namely that they fail to provide relevant results and often require significant computing resources to operate. The embodiments disclosed herein utilize specific combinations of machine learning and natural language processing techniques to optimize the results of classification, tagging, and matching operations. Specifically, the embodiments disclosed herein describe techniques that utilize semantic properties of documents to automatically surface tags that may not be readily apparent using the simplistic techniques discussed above. Additionally, the embodiments disclosed herein remedy the aforementioned deficiencies by utilizing multiple machine learning models to dynamically recommend suggested tags. As disclosed herein, the embodiments allow for the generation of suggested tags including tags that do not appear in the document themselves. Finally, the embodiments disclosed herein improve current techniques and increase the computing accuracy in recommending similar documents. Additionally, the scalable nature of the embodiments enable the analysis of significantly more documents than can be handled using current techniques. Additionally, some embodiments utilize specific user profile data to further refine suggested documents.

### BRIEF SUMMARY

To remedy the aforementioned deficiencies, the disclosure describes systems, devices, and methods for automated document analysis and processing using machine learning techniques.

With respect to the classification of documents, embodiments disclosed herein illustrate methods and systems for automatically classifying documents. In some embodiments, the methods can be utilized to classify PDF documents or other document formats. In some embodiments, the method can be utilized in various subject matter domains such as financial documents or other similar areas where, for example, PDF documents are commonly utilized.

At a high-level, of the methods (and systems employing the methods) can be split into two stages: training and predicting. The disclosed embodiments, rely on having a training set of documents whose categories are known, so that a machine learning pipeline can be developed that creates various models that learn the characteristics from each individual observation or document and finds relationships between those characteristics and one or more categories or tags. The disclosed embodiments employ supervised learning and the end results are systems and methods that are able to receive a document and identify the categories or tags it belongs to.

The accuracy of the models necessarily depends on the learning algorithm and on the information it is given. For instance, raw PDF data cannot simply be input into the models and the models cannot be expected to learn automatically due to the “curse of dimensionality,” which is related to the amount of data needed to obtain statistically reliable results, and so the content of documents must be prepared and processed in order to obtain enough information to accurately predict the output with a reasonable number of documents.

As for the content itself (after parsing) multiple modules are disclosed that deal with various aspects of the categories/tags. Exact tags are relatively straightforward, due to their nature, however, tags such as “commodities” required specific modules to handle them. The core of the methods and systems utilizes contextual linguistic models that learn cues from the text, using what is called “word embedding.” The systems and methods use the neural networks that are used in many domains such as self-driving cars, language translation and natural language processing.

The contextual models are built using the training documents but they can't classify on their own, one purpose of the models is to understand the context of certain words and terms (e.g. “international trade” and “stock trading” are contextually different). They are, however, used during the training stage in conjunction with a series of statistical analysis methods that makes decisions on what terms are used in certain tags and this is how the systems and methods start to understand how certain documents are being tagged. It's important to note that the amount of documents is crucial to the final quality of the results because if a small sample is given the model can be induced to learn the wrong context for a certain tag or category. For example, if we are trying to learn the tag “Commodities” and by chance, all the training documents about “Commodities” are also talking about “China,” the model might incorrectly assume that “Commodities” is directly related to the tag “China” and might start returning that tag in every mention of “China.”

In some embodiments, the output of the disclosed methods and systems is a set of tags/categories used to classify a set of documents. Users can use these tabs to search explore a set of documents. Additionally, the user can quickly understand the content of a large document set based simply on the categories or tags extracted from it.

The systems and methods described herein, due to the unique combination and arrangement of various machine learning components, results in a significantly higher tagging accuracy of documents.

Additionally, the systems and methods enable users to search for documents by tags which complement existing search techniques such as full-text searching. In general, full-text search is not an adequate way to search for documents, especially if the user wants to find documents by subject instead of having a set of keywords. Thus, the disclosed methods and embodiments that classify documents based on tags/classes, which represent more high level subjects, provide a clear advantage when it comes to finding relevant documents. Having a predefined structure of tags enables two important features in searching for information: it enables the browsing of documents by tag/category and enables searching documents by tag/category. It also enables a more accurate comparison of documents based on topics and not on superficial features.

With respect to suggestion of new tags for documents, the embodiments disclosed herein can suggest new tags (tags not defined in the predefined tags) for the untagged document. In general, the disclosed embodiments utilize three discrete modeling techniques (although more or less may be used).

First, the embodiments use a lexico-statistic rules that analyses a set of documents and searches for lexical patterns that are statistically relevant in the text and which are not already in a current hierarchy of tags. A lexico-statistic approach may include various techniques such as is the statistically relevant, which can comprise a set of techniques, like co-occurrence or more complex ones, such as Latent Semantic Indexing (LSI). In some embodiments, a lexico-statistic approach might need to look beyond a list of provided documents, which means sampling the new tags against previously stored documents. If an administrator decides to classify all previously stored documents with a tag (using a lexico-statistic approach), then the classification pattern must be applied to all the documents, except the ones already analyzed in the discovery process. The application of the classification patterns is very fast due to its simplicity, since no statistical analysis is required and is best suited for those tags that explicitly appear in the text and that are more specific (in contrast to more abstract tags).

Second, the embodiments use a dictionary-based approach which is based on a domain specific dictionary preloaded (but that can be updated) in which specific domain concepts are defined in terms of texts (for instance, it can be a page from Investopedia or from Wikipedia that explains the concept). This approach detects these concepts in the set of documents that were given as input. The detection mechanism can comprise simple measures of similarity like n-gram similarity measures to more complex summarization or Rhetoric Structure Theory methods. In this approach, the detection mechanism is applied at a local level of the target documents against the page definition of the concepts. This is a heavy procedure in the sense that in the case of being applied to previously stored documents, the approach requires significant computing power. In some embodiments, documents are processed using this approach in the background when the overall system is experiencing low usage. This approach has the ability to bring abstract concepts already validated in the target domain and commonly accepted, which makes it an important method to discover new tags that are abstract, in contrast to the lexico-statistic approach, which is a specific-oriented approach.

Third, the embodiments use a topic modeling approach which is a complex methodology to detect lexico-statistic patterns of abstract topics in the text. These topics might be already known concepts to humans, in which the human can easily recognize it by the output of the process, or new concepts that are lexico-statistically relevant, but which are not already known to humans. This approach is based on LDA (Latent Dirichlet Allocation)-like algorithms and is based on a set of given documents tries to uncover lexico-statistically relevant patterns of terms that define a topic discovered in the documents. This approach has the ability to discover new topics that might not be known to the domain, or to identify already known ones without a previous list of concept definitions. It is an important method to discover new tags that are abstract, in contrast to the first approach, which is a specific-oriented approach, and it goes well beyond the second approach. Be aware that this approach has a rate of suggestion of tags lower than the other modules and that it might also have lower acceptance rate, since it is a more abstract approach.

With respect to the detection of related documents, the embodiments disclosed herein are based on a content-based filtering approach. Understanding the content of the documents is an elaborate task and to improve performance, embodiments first split content into various high-level factors such as: “Title”, “Text/Summary”, “Date”, “Source” and “Tags”. For each of these high-level factors multiple modules were developed. One of these modules is a contextual model that is developed by learning contextual cues from thousands of documents and definitions. This model is then used on the title and summary to calculate a contextual vector (e.g. with a large enough amount of documents, this model is able to understand that “international trade” and “stock trading” are contextually different, even if they share the word “trade”). This contextual module is used in conjunction with another module that performs statistical analysis on each document term, so that the system can provide more interest to certain terms and ignore others when calculating the contextual vector (e.g. “volatility” is an interesting term, “nevertheless” is not an interesting term).

When comparing tags between documents, the tags in common cannot simply be matched because the number of tags changes widely from document to document and each tag can have a different worth. The disclosed embodiments utilize a points system that allows for the specification of broad rules such as making “Region” tags worth more than “Asset” tags, while allowing fine-tunings such as increasing the points associated with certain regions. In addition to this, while a document has various tags, some of them are more relevant than others for that specific document; this means that while each tag has a global “importance”, that importance changes according to each document.

The embodiments also distinguish between expressions with special worth. This included expressions such as “Healthcare” or “Analyst Coverage,” that were not tags but were sometimes the most important topic of a document. Embodiments disclosed herein utilize a large amount of domain-specific terms as base, including synonyms and asset keywords from the database, and allow for custom user-inputted expressions with variable weights.

Other high-level factors required different strategies, for instance a “Date” factor requires a numerical score representation based on how old that “Date” was. For this, various embodiments are disclosed that represent this decay, from using a simple “Linear” formula, to more refined ones such as using a combination of a “Sigmoid” and “Quadratic” decay.

Additional miscellaneous embodiments include chunk comparison, pre-processing of terms to their lemma form, finding correlated tags etc., for each one of these embodiments and their high-level factors a weight is used based on the document type and other elements.

### BRIEF DESCRIPTION OF THE DRAWINGS

The embodiments are illustrated by way of example and not limitation in the figures of the accompanying drawings in which like references indicate similar elements.

FIG. 1A is a flow diagram illustrating a method of training a document classifier according to some embodiments of the disclosure.

FIG. 1B is a flow diagram illustrating a method of classifying a document utilizing a classifier according to some embodiments of the disclosure.

FIG. 2 is a block diagram illustrating a system for classifying documents utilizing a classifier according to some embodiments of the disclosure.

FIG. 3 is a flow diagram illustrating a lexico-statistic method for identifying new tags for a document according to some embodiments of the disclosure.

FIG. 4 is a flow diagram illustrating a dictionary-based method for identifying new tags for a document according to some embodiments of the disclosure.

FIG. 5 is a flow diagram illustrating a topic modeling method for identifying new tags for a document according to some embodiments of the disclosure.

FIG. 6 is a block diagram illustrating a system for identifying new tags for a document according to some embodiments of the disclosure.

FIG. 7 is a flow diagram illustrating a method for identifying documents related to a target document according to some embodiments of the disclosure.

FIG. 8 is a block diagram illustrating a system for identifying documents related to a target document according to some embodiments of the disclosure.

### DETAILED DESCRIPTION

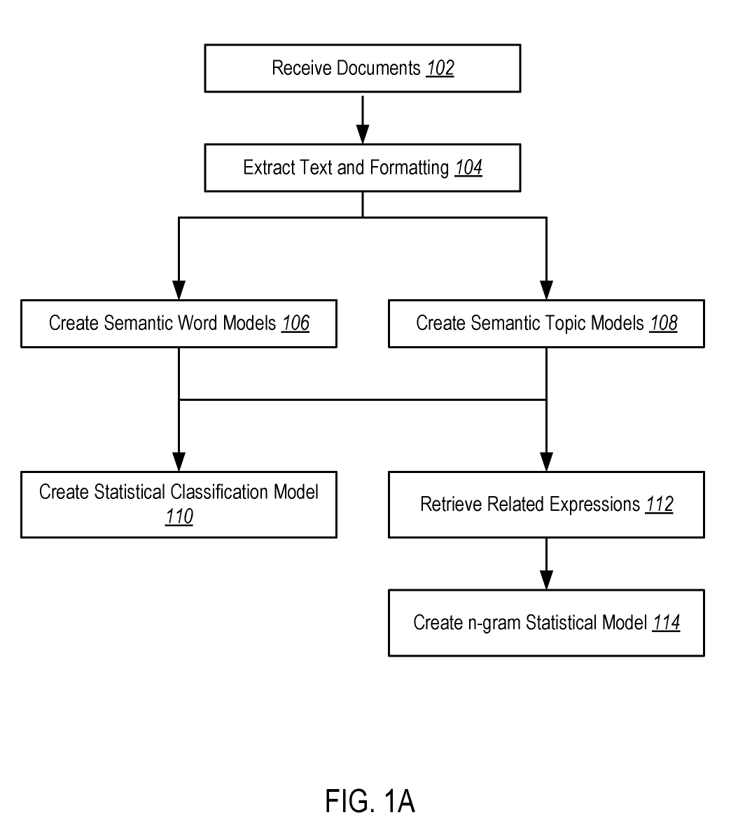

FIG. 1A is a flow diagram illustrating a method of training a document classifier according to some embodiments of the disclosure.

In step 102, the method receives a set of documents. In some embodiments, a set of documents comprises a set of Portable Document Format (PDF) documents. In some embodiments, the documents comprise images and text. In some embodiments, the documents comprise only images, and text information is extracted from the images using optical character recognition (OCR). In some embodiments, the received documents can comprise, as an example, financial reports.

In step 104, the method extracts textual content and formatting content from the documents.

In one embodiment, the method utilizes a parser to extract textual and formatting content from the received documents. In some embodiments, a parser comprises a combination of software and hardware designed to load a document and extract textual and formatting content. In some embodiments, the parser filters a portion of the textual and formatting content from the received documents according to a set of rules.

In some embodiments, the parser removes content (textual/formatting) from the received documents to reduce the amount of “noise” data present within a received document. In some embodiments, rules regarding the removal or extraction of content comprises one or more of the following rules: (1) removing tables or images appearing within a document; (2) detecting the presence of a title within the document; (3) normalizing column layouts of documents (e.g., identifying two-column or multi-column documents and converting these columns to a single column); and (4) removing entire sections of “boilerplate” text content (e.g., disclaimers, etc.).

In some embodiments, removing tables or images comprises parsing the formatting content of a document to identify the start and end of a table or image section. For example, in an HTML document, the method can detect the presence of a <TABLE> tag and a </TABLE> tag to detect the start and end of a table respectively. For PDF documents, the method can detect the presence of line objects that denote the start and end of a table (e.g., horizontal lines with vertical side bars). In some embodiments, for PDF documents, the method can parse individual tokens of the PDF document in order to detect a table start. Similar techniques can be used to detect the presence of images. By detecting tables and images, the method can filter a text representation of a document to remove, for example, text appearing within images or tables that represent ancillary content as compared to the majority of a document.

In some embodiments, the method also identifies a title associated with a document. For HTML documents, the method extracts a title by identifying a <TITLE> element or by identifying a top-level header (e.g., <H1>) tag. For PDF documents, the method extracts a title by identifying a “TITLE” metadata tag. Alternatively, or in conjunction with the foregoing, the method extracts a title from a PDF document by identifying a portion of a document appearing on the first page of the document and appearing in a larger font.

In some embodiments, the method also identifies multi-column documents and converts these documents into single column documents. With respect to PDF documents, the method identifies specific metadata tokens indicating the column layout. For example, the method can identify a ColumnCount or similar token to identify content appearing with a column of a PDF document. In this embodiment, the method parses a page of a document to collapse each column into the first column, thus generating a single-column representation of each page.

In some embodiments, the method also identifies boilerplate language appearing in documents. In some embodiments, the method utilizes a list of tokens identifying boilerplate language. For example, the token “Disclaimers” can be used to identify the start of a section that includes disclaimers.

Additionally, in some embodiments, the method (in step 104) identifies the source of a document. In some embodiments, identifying the source of a document comprises comparing the extracted (and filtered) text to a library of previously identified documents containing similar textual content. Alternatively, or in conjunction with the foregoing, the method can compare portions of text to source-identified portions of text. For example, the method can utilize a library of “boilerplate” sections associated with known source and, when filtering the boilerplate sections of a document under inspection, can compare the filtered boilerplate to known boilerplates.

Alternatively, or in conjunction with the foregoing, the method utilizes an image-based search engine to identify visually similar images to one or more pages of a document. For example, a document under inspect can include a “cover” page. The method can compare this cover page image to source-identified cover pages to predict the source of the document. The method can utilize various machine learning techniques such as label detection, logo detection, image attribute detection, or various other computer vision techniques. In general, any computer vision technique can be utilized that receives an image and generates a representation of the image in semantic terms.

In step 106, the method creates a semantic word model for each document based on the extracted text and formatting of documents.

In general, the method creates a semantic word model for a given document which comprises a vector space associated with a document. In some embodiments, the method utilizes n-gram based algorithms to generate the vector space. In one embodiment, the method utilizes neural network techniques (e.g., neural probabilistic language models) to generate the vector space. In some embodiments, the method creates a semantic word model using the word2vec algorithm and toolkit. When using word2vec, the method can utilize either the continuous bag-of-words model or skip-gram model. In general, the method in step 106 computes each word form's semantic similarity taking into account the word form occurrences in input texts.

In step 108, the method creates a semantic topic model for each document based on the extracted text and formatting of documents.

In some embodiments, a semantic topic model is created using one or more machine learning algorithms. In general, a semantic topic model is created using a topic modeling algorithm. A topic modeling algorithm takes as input a parsed document and outputs one or more topics associated with the document. A topic modeling algorithm extract a set of topics using techniques including, but not limited to, LDA (Latent Dirichlet Allocation), which takes into account the probability distribution of words over the document text to identify clusters of words that can constitute topics. There is a degree of “belonging” of each word to each topic, and a word can belong to more than one topic, usually with different degrees of belonging. In some embodiments, topic modeling is performed using a probabilistic latent semantic analysis algorithm, Pachinko allocation or similar topic modeling algorithm.

As illustrated, step 106 and 108 may be performed in parallel. In alternative embodiments, the semantic word models can be used to create the semantic topic model. For example, the method can utilize vector operations between words to identify topics (e.g., computing distances between word vectors).

In step 110, the method creates a statistical classification model for the received documents.

In some embodiments, a statistical classification model takes, as input, the parsed documents and generates a probabilistic distribution for each word co-occurrence with a specific class. In general, the statistical classification model uses statistical information to extract probabilistic distributions of the correlation between words and classes.

In some embodiments, creating a statistical classification model comprises utilizing a keyword model generator to generate the classification model. In some embodiments, the semantic word models and semantic topic models are combined by using the contextual vector of each word form and weighting it by the topic in which the respective word form participates. The result is a probabilistic distribution for each word co-occurrence with a specific class, which can be related with a topic. In some embodiments, the creation of a statistical classification model further utilizes as an input a database of related words (e.g., synonyms, known expressions, etc.) and the outputs of the semantic word model and the semantic topic model generation steps. In some embodiments, the keyword model generator extracts several keywords from the input texts using several NLP techniques, at two levels: lexical level and syntactic level.

In step 112, the method retrieves related expressions.

In some embodiments, related expressions comprise synonyms to known tags. In some embodiments, related expressions may be defined by a system administrator. For example, related expressions for an acronym (e.g., “ECB”) may be expanded into the expression “European Central Bank.”

In step 114, the method generates an n-gram statistical model.

In some embodiments, an n-gram statistical model is created using related expressions (e.g., synonyms, known expressions, etc.) and the outputs of the semantic word model and the semantic topic model generation steps. In some embodiments, the method generates an n-gram statistical model based on a set of natural language text (e.g., the received documents) and outputs a set of n-grams. In some embodiments, the method selects the n-grams (i.e., a combination of sequential word forms that occur in natural language texts) with the highest frequencies as being the most relevant ones for the received documents. In some embodiments, the method searches for the related expressions (and tags) in the text to extract n-grams within the text in a nearby word window of N words, where N can be set as a parameter. The co-occurrence of these n-grams are used to create probabilistic distribution models in relation to a specific tag, because the system knows which related expression is associated with what tag. In some embodiments, the identified tags may be associated with a set of tags (e.g., “asset” tags, “asset class” tags, “topics” tags, and “geographic region” tags).

Thus, at the end of the method illustrated in FIG. 1A, the method has trained two separate models: a statistical n-gram model and a statistical classification model. These two models may then be used to automatically tag or classify new documents as described more fully in connection with FIG. 1B.

FIG. 1B is a flow diagram illustrating a method of classifying a document utilizing a classifier according to some embodiments of the disclosure.

In steps 116 and 118, the method receives a document and extracts textual and formatting information from the document. Steps 116 and 118 may be performed in a manner similar to that described with respect to steps 102 and 104, the disclosure of which is incorporated herein by reference in its entirety.

In step 120, the method predicts one or more suggested tags for the received document and assigns a confidence level, relevancy level and explanation for each tag.

In the illustrated embodiment, the method utilizes the statistical classification model and n-gram statistical model to predict a set of tags for a given document.

In the illustrated embodiment, the statistical classification model and n-gram statistical model are associated with tags, and are used, along with the information extracted from the received document, to statistically identify the topics that have a higher correlation with the word forms and n-grams that are in the target document. The weighted sum of all these correlations are then used to assess the confidence level and relevance level of each tag to the target document. The word forms and n-grams that are more relevant and are found in the target document are used to justify the tag attribution.

In step 122, the method provides the suggested tags.

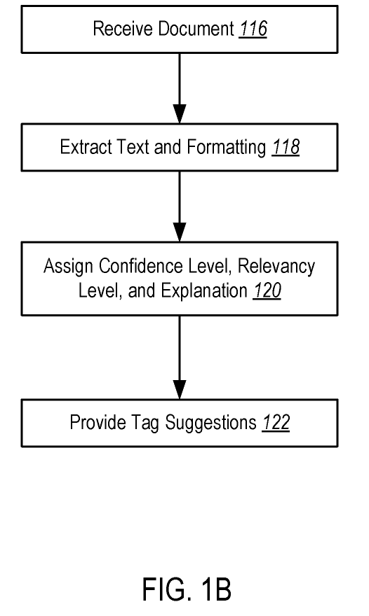

As described in more detail with respect to FIG. 2, the output of the statistical classification model and n-gram statistical model may be utilized to generate a set of tags (including relevancy levels, confidence levels, and explanations) which may then be transmitted to a user (e.g., via a website, desktop application, or mobile application).

FIG. 2 is a block diagram illustrating a system for classifying documents utilizing a classifier according to some embodiments of the disclosure.

As illustrated in FIG. 1C, a system includes a document processing subsystem (202), a model training subsystem (204), and a prediction subsystem (206). In the illustrated embodiment, each subsystem may be implemented on one or more computing devices (e.g., a dedicated server). For example, document processing subsystem (202) may comprise one or more application servers configured to receive documents from external devices. In general document processing subsystem (202) and model training subsystem (204) are utilized to implement the methods described in connection with FIG. 1A while model training subsystem (204) and prediction subsystem (206) are utilized to implement the methods described in connection with FIG. 1B.

Document processing subsystem (202) receives a set of training documents (204). In some embodiments, these documents are received from third parties or are stored in a database of training documents. In some embodiments, the training documents (202a) are each associated with one or more tags. In some embodiments, these tags are manually entered by a user. Notably, training documents (202a) comprise a limited number of documents due to the requirement of manual tagging. Alternatively, or in conjunction with the foregoing, the documents (202a) can be routinely updated as needed. As illustrated, document processing subsystem (202) includes a parser (202b) that receives (e.g., via network interface) the training documents (202a) and generates a textual/formatting representation of the documents as described more fully in connection with FIGS. 1A-1B.

The system (200) additionally includes a model training subsystem (204). In the illustrated embodiment, the model training subsystem (204) receives parsed training documents from document processing subsystem (202) via a well-defined interface. In some embodiments, model training subsystem (204) receives documents via a network interface.

Model training subsystem (204) feeds the parsed documents into semantic word model generator (204a) and semantic topic model generator (204b). These modules create semantic word models and semantic topic models for the parsed documents, respectively. In the illustrated embodiment, these modules implement the methods described more fully in connection steps 106 and 108 of FIG. 1A, the disclosure of which is incorporated herein by reference in its entirety.

Semantic word model generator (204a) and semantic topic model generator (204b) store the generated models in semantic word model storage (204c) and semantic topic model storage (204d). In some embodiments, these storage devices comprise relational databases, NoSQL databases, or any suitable data storage device.

Model training subsystem (204) additionally includes an n-gram model generator (204e) and a keyword generator (204f) configured to generate n-gram statistical models and statistical classification models, respectively. These generators (204e, 204f) are communicatively coupled to a related terms database (204g) via a network interface or similarly suitable interface. In the illustrated embodiment, n-gram model generator (204e) and a keyword generator (204f) are configured to generate models as described more fully in connection with steps 110-114 of FIG. 1A, the disclosure of which is incorporated by reference herein in its entirety.

In the illustrated embodiment, statistical classification models and n-gram statistical models are stored, respectively, in storage devices (204h, 204i). In some embodiments, these storage devices comprise relational databases, NoSQL databases, or any suitable data storage device.

System (200) additionally includes a prediction subsystem (206). In some embodiments, prediction subsystem (206) includes one or more front-end application servers (206b) for receiving a document (206a) from, for example, a user or client device over a network such as the Internet. In some embodiments, application server (206b) may preprocess the document using, for example, parser (202b). Application server (206b) forwards the (optionally parsed) document to classifier (206c). In some embodiments, the classifier (206c) comprises the models generated by model training subsystem (204). The classifier (206c) analyzes the document (206a) and generates a set of suggested tags as described previously. Prediction subsystem (206) then stores the tag in tag storage (206d). In some embodiments, the prediction subsystem (206) is further operative to transmit the suggested tags to the user for subsequent display. For example, prediction subsystem (206) can generate a webpage identifying the suggested tags and providing interactivity (e.g., allowing users to search a set of documents using a suggested tag).

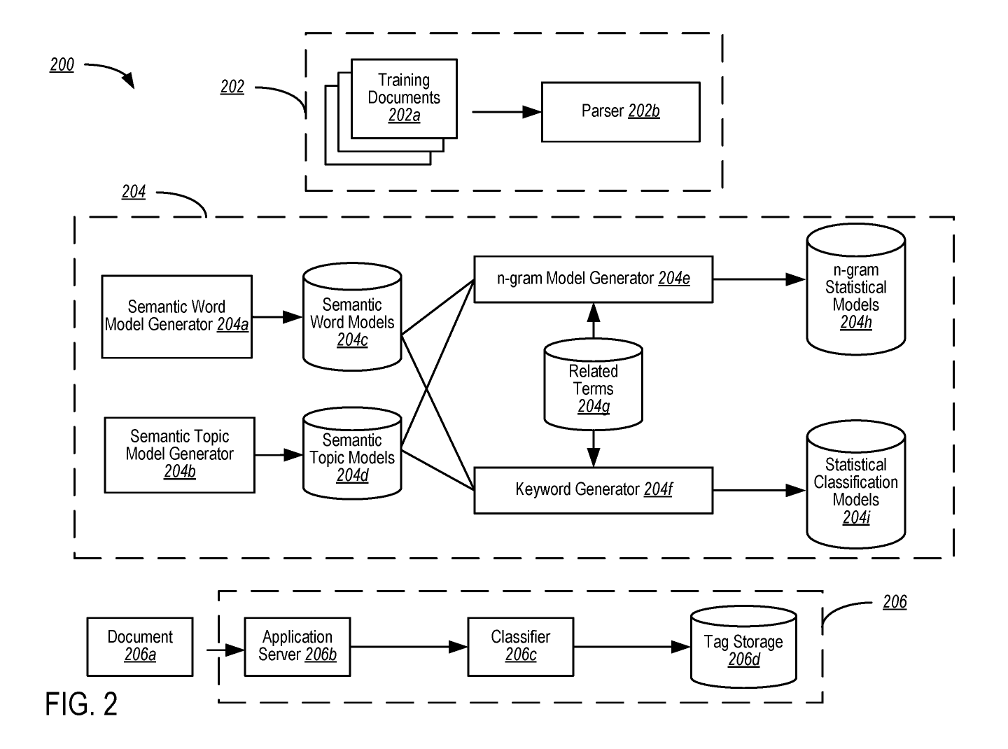

FIG. 3 is a flow diagram illustrating a lexico-statistic method for identifying new tags for a document according to some embodiments of the disclosure.

In step 302, the method receives a set of documents.

In some embodiments, the method may, prior to executing step 304, perform tokenization, chunking, and contextual model generation on the documents. In some embodiments, the pre-processing operations may be performed on-demand so that new documents may be added to the documents without requiring pre-processing all of documents.

In step 304, the method identifies lexical patterns in the documents that are statistically relevant to the document text.

A lexical pattern generally comprises a linguistic expression including tokens such as verbs, adjectives, nouns, adverbs and combinations of these, as well as formatting (bold, caps, etc.) and morphological (verb tenses, plural and singulars, etc.) variations. In one embodiment, the method utilizes a co-occurrence algorithm to determine whether a particular pattern is statistically relevant. In some embodiments, using a co-occurrence algorithm comprises generating a co-occurrence matrix. Alternatively, or in conjunction with the foregoing, the method utilizes latent semantic indexing (LSI) to identify a statistically relevant pattern. In some embodiments, LSI receives a set of natural language texts and generates one or more relationship patterns between word forms within the set of texts. An LSI process analyzes the relationships between word forms to extract statistical pattern between word forms.

In some embodiments, the method utilizes regular expression rules to identify statistically relevant word form patterns, taking into account the sequence of words. In alternative embodiments, the method may chunk each document to identify, for each document, noun phrases in the text that occur several times. In some embodiments, this embodiment may utilize word form normalizations such as stemming and lemmatization. In alternative embodiments, the method may utilize specific word form patterns to identify expressions. For example, the word form pattern “<Noun|Adjective><Market, Lemma>” may be utilized to match expressions such as “Global Markets” or “Asian Market.”

In some embodiments, the method may additionally rank the frequency and position of the identified patterns and generate an interim relevancy level for each pattern. For example, identified expressions appearing more frequently may have their relevancy increased.

In step 306, the method filters patterns already in a tag hierarchy.

As described previously and herein, a corpus of documents may be associated with a tag hierarchy. In step 306, after identifying lexical patterns, the method removes all lexical patterns that correspond to tags in the tag hierarchy. In some embodiments, the method may additionally utilize a dictionary of synonyms to remove lexical patterns sufficiently similar to existing tags. In this manner, the method filters out known tags and identifies a set of potential new tags.

In step 308, the method ranks the relevant patterns. In some embodiments, this ranking may utilize the values output by the lexical pattern matching techniques used in step 304.

In step 310, the method provides the ordered documents, patterns, and relevancy measurements. In some embodiments, the return value of the method illustrated in FIG. 3 includes the documents that comprise the pattern/tag, the lexical pattern that originated the tag, the statistically relevant measures associated with the tag, which can then be condensed into a confidence level. In some embodiments, the output of the method illustrated in FIG. 3 may be utilized by a system administrator to place a new pattern within the existing tag hierarchy.

In some embodiments, the method may utilize documents other than those received in step 302. In this embodiment, the method samples the identified patterns (in steps 306-308) against previously stored documents. As one example, if an administrator decides to classify all the previously stored documents with a newly detected tag, then the classification pattern must be applied to all the documents, except the ones already analyzed in the discovery process. In this case, the application of the classification patterns is very fast due to its simplicity, since no statistical analysis is required.

Notably, the above-described method is best suited for those tags that explicitly appear in the received text and that are more specific (in contrast to more abstract tags). An example of use is the type of “new” terms that appear in documents like “Brexit” or more recently “Bremain.”

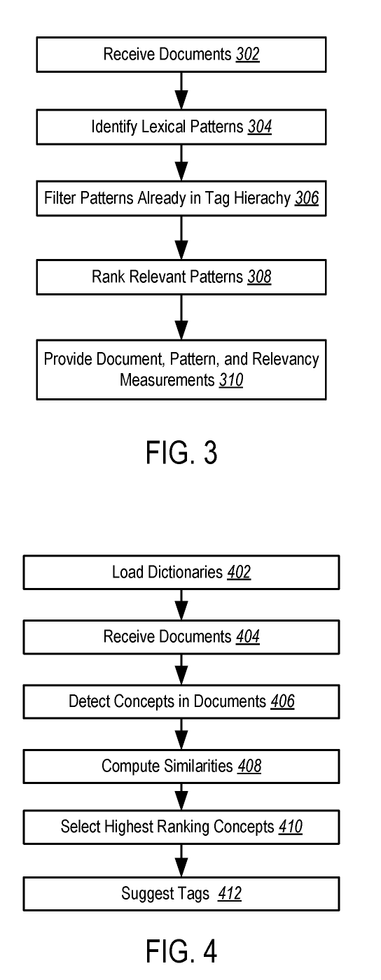

FIG. 4 is a flow diagram illustrating a dictionary-based method for identifying new tags for a document according to some embodiments of the disclosure.

In step 402, the method loads one or more dictionaries. In some embodiments, a dictionary comprises a domain-specific database mapping terms or expressions or concepts to textual documents. In some embodiments, a dictionary is created manually via one or more editors. In alternative embodiments, a dictionary is created programmatically by, for example, extracting data from known sources. For example, the method can extract terms/expressions/concepts from online web sources (e.g., Wikipedia or Investopedia) to generate a domain-specific dictionary.

In step 404, the method receives a set of documents. In some embodiments, a document comprises a PDF or HTML document as discussed previously.

In step 406, the method detects one or more concepts in the document, and in step 408, computes similarities between the detected concepts and the concepts stored in the loaded dictionaries. The detection of concepts utilizes one or more statistical classification methods described herein.

In one embodiment, the method utilizes an n-gram similarity measurement to determine whether the document includes one or more n-grams that correspond to defined concepts present in the loaded dictionaries. In some embodiments, the choice of n may be modified according to the methods needs. In some embodiments, an n-gram similarity measurement generates a set of n-grams given a set of natural language texts. In general, an n-gram similarity measurement computes the similarity between two n-grams taking into account word forms and word sequences. Alternatively, or in conjunction with the foregoing, the method may utilize an automatic summarization machine learning algorithm (e.g., textsum) to first process the received documents and extract a “summary” of each document. Alternatively, or in conjunction with the foregoing, the method may utilize rhetorical structure theory methods to extract concepts from a received document.

In step 410, the method selects one or more of the highest ranking concepts, wherein the concepts are ranked based on their similarity to known concepts as discussed previously.

In step 412, the method suggests tags associated with the concepts. In some embodiments, a tag may be generated based on the identified concept in the pre-loaded dictionary (e.g., the term defined by a Wikipedia or Investopedia page). In some embodiments, a suggestion includes a set of documents already associated with the tag, a definition page (e.g., from a dictionary or webpage that originated the tag), and a similarity score associated with the tag. In some embodiments, a similarity score represents a confidence level that the tag was appropriately selected using the machine learning method(s) in step 406. In some embodiments, the output of the method illustrated in FIG. 4 may be utilized by a system administrator to place a new pattern within the existing tag hierarchy.

In general, the method illustrated in FIG. 4 can be utilized when concepts are already established in a target domain or field and are thus commonly accepted.

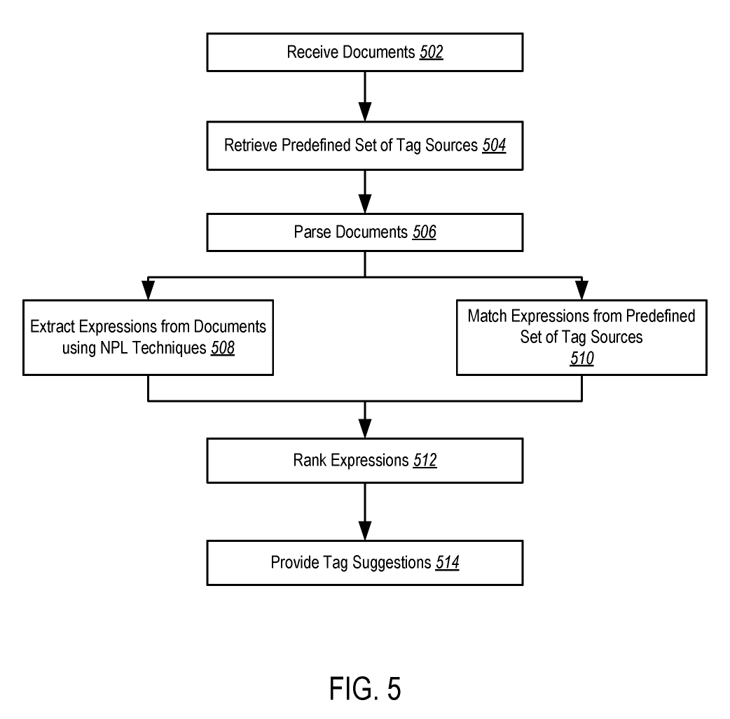

FIG. 5 is a flow diagram illustrating a topic modeling method for identifying new tags for a document according to some embodiments of the disclosure.

In step 502, the method receives a set of documents and, in step 504, receives a predefined set of tag sources.

In some embodiments, the predefined set of tag sources comprises dictionaries, webpages, etc., as discussed more fully in connection with FIG. 4, the disclosure of which is incorporated herein by reference in its entirety.

In step 506, the method parses the received documents.

In some embodiments, the parsing of documents comprises the extracting of raw text and formatting as discussed more fully in connection with FIG. 1A, the disclosure of which is incorporated herein by reference in its entirety.

The method then extracts candidate expressions in steps 508 and 510. As illustrated, steps 508 and 510 may be performed in parallel or in sequence.

In step 508, the method extracts candidate expressions from the documents using natural language processing techniques.

In one embodiment, the method may utilize a Latent Dirichlet Allocation model to identify candidate expressions. As described previously, LDA takes into account the probability distribution of words over the input texts to identify clusters of words that can constitute topics. There is a degree of “belonging” of each word to each topic, and a word can belong to more than one topic, usually with different degrees of belonging. In some embodiments, topic modeling is performed using a probabilistic latent semantic analysis algorithm, LDA, Pachinko allocation or similar topic modeling algorithm.

In step 510, the method matches expressions within the received documents with a predefined set of sources.

In some embodiments, the method may utilize all the sources retrieved in step 504. In alternative embodiments, the method may use a limited number of sources (e.g., only academic papers). In some embodiments, each source may analyzed using an n-gram modeling techniques to identify a plurality of expressions from the set of sources. These expressions may then be used to determine whether the received documents include any of the identified expressions from the sources.

In step 512, the method ranks the identified expressions extracted in steps 508 and 510.

In some embodiments, the method utilizes a scoring function to rank the identified expressions detected in steps 508 and 510. In one embodiment, the LDA algorithm used in step 508, associates a probability to each tag (or topic) being present in a given document. This probability is based on the word form probability distribution associated with each topic and how many times and where these word forms are present in each input documents. The sum of all topic candidates across all the documents is then used as a score for each topic candidate.

In step 514, the method provides tag suggestions based on the expression ranking.

In some embodiments, the tag suggestions include a topic, a list of word/term-score pairs defining the topic, the documents that comprise the topic, and a similarity score or confidence level.

As illustrated in FIGS. 3-5, various specific techniques for discovering new tags in documents may be utilized to generate a listing of new tags. Since each method outputs a tag and a confidence level (or similarity measurement), some or all of the methods described in FIGS. 3-5 may be combined to generate an aggregated listing of relevant tags/expressions.

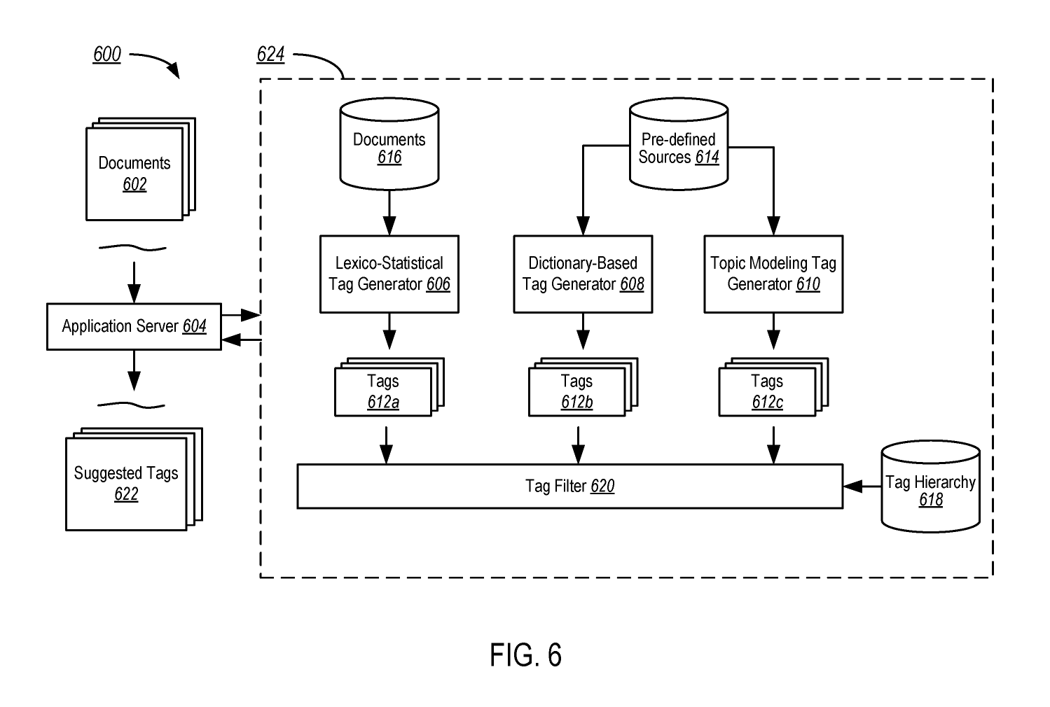

FIG. 6 is a block diagram illustrating a system for identifying new tags for a document according to some embodiments of the disclosure.

In the illustrated embodiment, the system (600) may perform the functions described in connection with FIGS. 3-5 and complete disclosure of the steps discussed in connection with FIGS. 3-5 are not repeated herein for the sake of clarity.

In the illustrated embodiment, a user may transmit one or more documents (602) to an application server (604). In some embodiments, documents may be submitted to an application server (604) via a web page, desktop application, mobile application, or other graphical user interface allowing for the upload of documents from a client device to application server (604). Although illustrated as a single device, multiple application servers (604) may be utilized to increase the throughput of the system (600). Additionally one or more load balancers may be utilized to increase the throughput of the system.

Application server (604) additionally transmits suggested tags (622) to a client device (e.g., the client device transmitting the documents 602). In order to obtain the suggested tags (622), the application server (604) transmits the documents (602) to subsystem (624), described in more detail herein. In some embodiments, subsystem (624) may be located remotely from application server(s) (604). For example, application servers (604) can be located geographically throughout a region (or the world) whereas subsystem (624) may be deployed in a single location.

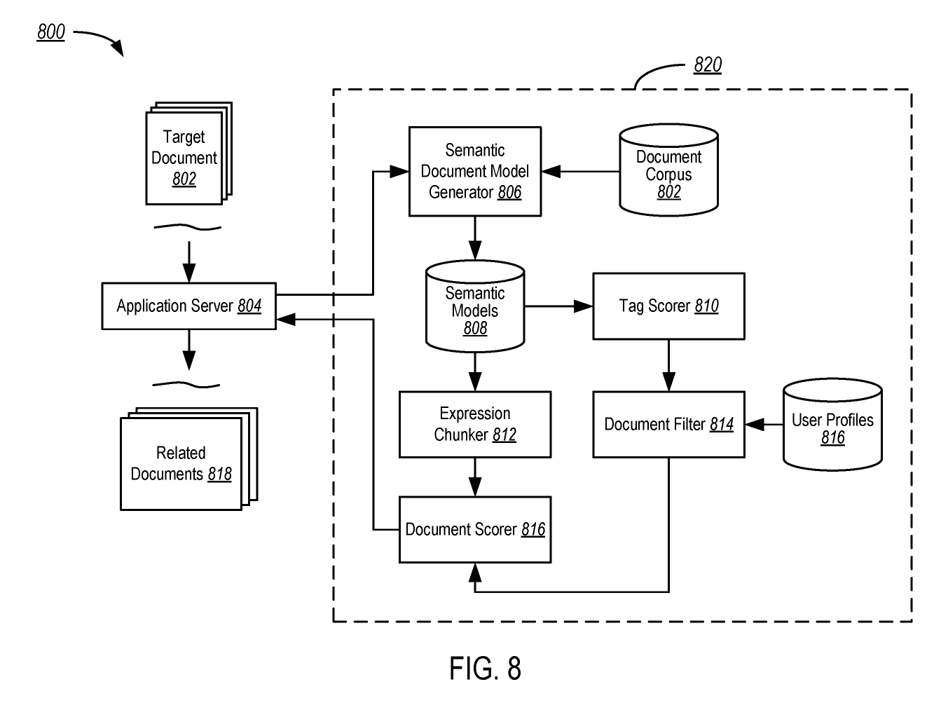

Subsystem (624) includes a lexico-statistical tag generator (606), a dictionary-based tag generator (608), and a topic modeling tag generator (610) which, in some embodiments, are configured to perform the methods described in FIGS. 3, 4 and 5, respectively. The disclosure of FIGS. 3-5 is not repeated herein for the sake of clarity but is incorporated by reference in its entirety. Each of the devices (606, 608, 610) may comprise one or multiple physical or virtualized server which may be instantiated on demand as discussed in more detail in FIG. 8.

Lexico-statistical tag generator (606) is configured to generate one or more tags (612a) based on lexical expressions identified in the documents (602) as described in FIG. 3. Document storage (616) may comprise any relational, non-relational, or filesystem storage device capable of storing previously tagged documents. This storage device (616) can be used to sample the identified tags (612a) against previously stored documents as described previously.

Dictionary-based tag generator (608) is configured to generate one or more tags (612b) based on the similarities of concepts between the documents (602) and one or more documents stored in pre-defined sources storage (614) as described more fully in connection with FIG. 4. Pre-defined sources storage (614) may comprise any relational, non-relational, or filesystem storage device capable of storing canonical dictionary-type documents.

Topic modeling tag generator (610) is configured to receive the document (602) and extract one or more topics/tags (612c) associated with documents (602) as described more fully in connection with FIG. 5. As discussed in FIG. 5, topic modeling tag generator (610) utilized dictionary-related source in pre-defined sources (614) in order to match expressions between documents (602) and sources in storage (614).

As illustrated, each set of tags (612a, 612b, 612c) is transmitted to a tag filter (620). As discussed in connection with FIGS. 3-5, the output of each generator (606, 608, 610) is a set of tags wherein each tag is associated with at least a confidence or relevance level. Filter (620) is first configured to remove those tags already existing in tag hierarchy storage (618) and then rank the remaining tags from tag sets (612a, 612b, 612c) to generate a listing of suggested tags (622) extracted from documents (602).

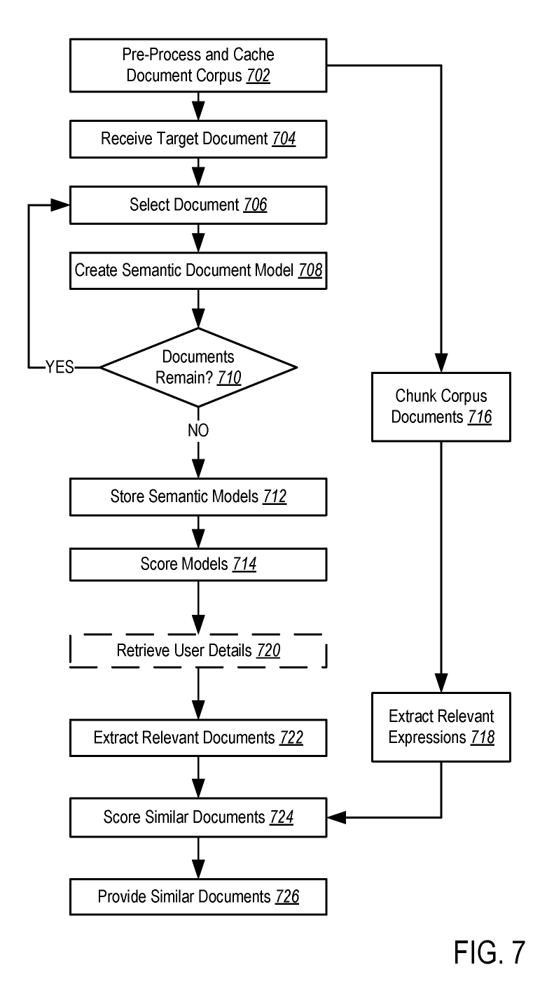

FIG. 7 is a flow diagram illustrating a method for identifying documents related to a target document according to some embodiments of the disclosure.

In step 702, the method pre-processes and caches a corpus of documents.

In some embodiments, pre-processing a corpus of documents may comprise performing various machine learning operations on the corpus. For example, the method can perform tokenization, chunking, and contextual model generation on the corpus of documents. In some embodiments, the pre-processing operations may be performed on-demand so that new documents may be added to the corpus without requiring pre-processing the entire corpus of documents.

In some embodiments, pre-processing documents may additionally include converting documents into a structured format. For example, a document may be preprocessed into a structure having various fields representing aspects of the document. These fields may include a title, the text (or summary) of the document, a date, a source of the document, and one or more tags associated with the document. In some embodiments, pre-processing may additionally include one or a combination of chunking the corpus of documents, lemmatizing the corpus of documents, identifying correlated tags. These pre-processing steps may further be weighted to increase or decrease the effect of the steps on the overall pre-processing of documents. In some embodiments, these fields may be automatically generated by using one or more contextual models (as described previously). For example, a summary of the document may be generated as discussed in connection with FIGS. 3-5. Likewise, a title may be extracted using the techniques discussed in connection with FIGS. 1A-1B.

In step 704, the method receives a target document. As discussed previously, a target document comprises a document of initially unknown relevance or content. In some embodiments, target documents are received from users and comprise PDF, plain text, HTML or other document types. In some embodiments, a target document comprises a document being viewed by a user (e.g., a webpage or PDF). In some embodiments, the target document includes tags and parsing information associated with the document.

In step 706, the method selects a document from the corpus of documents or from the received target document. Similar to the target document, the corpus of documents may include a plurality of documents, each document associated with tags and parsing information.

In step 708, the method creates a semantic document model of the selected document.

As illustrated, the method creates a semantic document model for both the corpus of documents and the target document. In some embodiments, the process of creating a semantic document model for each type of document is identical. In some embodiments, the creation of a semantic document comprises utilizing the Doc2Vec algorithm to convert the text of a document into a semantic document model. In general, a semantic document modeling algorithm is similar to a semantic word modeling algorithm (e.g., word2vec). Notably, however, a semantic document modeling algorithm analyzes entire sentences and documents of a document (rather than individual words) to generate document vectors usable for downstream processing. Thus, the output of the semantic document modeling process is a set of vectors representing the content of the document (i.e., the text) that can be used for comparison with other documents and to discover similarities between documents in a streamlined fashion. The use of vectors specifically allows for later machine learning processes to be executed on the documents. In some embodiments, the semantic document model can be combined with a semantic word model of the document in a combined word/document vector model space, allowing for comparison between document vectors and word vectors.

In step 710, the method determines if any documents remain and if so executes steps 706 and 708 for each remaining document.

In step 712, after determining all documents have been processed, the method stores the semantic models. In some embodiments, the method may store a semantic document model upon creating the semantic document model in step 708. In some embodiments, semantic document models may be stored on disk, in a database (e.g., a relational database), or other form of storage suitable for retrieving the models. In some embodiments, due the size of the vector space, the vectors generated in step 708 may distributed across multiple databases.

In step 714, the method scores the semantic document models as well as the tags and parsing information associated with the corpus of documents and the received document.

As discussed previously, each document processed in step 708 is associated with one or more tags and parsing information. In step 714, the method uses these tags and parsing information and the generated semantic document models to determine the relevancy of the tags to the document based on the document/word vector model of the document. That is, the method may calculate the cosine distance between a tag and the word vectors in the document vector space associated with the semantic document model. This results in a floating point value that is used as the “relevancy” of the tag to the document vector. In some embodiments, this process is repeated for each tag and for each document model.

In some embodiments, the method may further weight tags according to various rules. For example, when comparing tags between documents the tags in common cannot simply be matched because the number of tags varies significantly from document to document and each tag can have a different worth with respect to the document. Due to this variance, the method may utilize a “point system” that specifies various rules for fine-tuning the tag ranking algorithm. For example, the method may identify “regional”-related tags (e.g., country, metropolitan area) and increase the tag ranking for these tags. Conversely, the method may identify “asset”-related tags and decrease the tag ranking for these tags. Additionally, the method may utilize a per-document ranking model to increase the ranking of tags based on the context of the document. For example, a given tag (t1) globally may be of minor relevance, but for a given document may be of significant relevance. Thus, the method may inspect the content of the document itself to calculate the relative importance of the tag to the text of the document and increase the ranking appropriately.

In some embodiments, the method may additionally adjust tag scores based on the date of the document. For example, tag scores for older documents may be reduced while tag scores for fresher documents may be increased. In some embodiments, the method may utilize a linear, sigmoid, or quadratic decay algorithm to represent the decay in a document over time and utilize this decay as a scaling factor for the tag scores.

Thus, the method may generate an ordered list of “scored’ documents by using the semantic document models. In some embodiments, the output of step 714 comprises a tuple (or other data structure) including the document, the tag, and the relevancy score.

In step 720, the method optionally retrieves user details.

In some embodiments, user details comprise a history of documents viewed by a user. In some embodiments, these documents viewed by a user correspond to a subset of documents in the corpus of documents. In some embodiments, user details additionally include user interactions (e.g., bookmarks, search result hits, etc.) and user interests (e.g., via user profile or similar structure).

In steps 716 and 718, the method chunks the corpus documents (716) and extracts relevant expressions from the chunked corpus documents (718). As illustrated in FIG. 7, the chunking and expression extraction steps may be performed in parallel to steps 704-714 and 720-722. In some embodiments, the method may also chunk and extract expressions from the target document.

In one embodiment, the method partitions documents into one or more chunks. In some embodiments, a chunk size may be configured based on the types of documents. In some embodiments, the partitioning of documents may be based on grammatical rules (e.g., chunking a document in noun, verb, preposition, etc. chunks).

In some embodiments, after chunking a document, the method analyzes each chunk to identify relevant phrases. Methods for identifying relevant expressions in text are described more fully in connection with FIG. 5, the disclosure of which is incorporated herein by reference in its entirety. In alternative embodiments, the method may utilize a list of known expressions, synonyms, and asset keywords stored within a database to identify relevant expressions. Alternatively, or in conjunction with the foregoing, the method may allow for user-defined expressions to be included within the database.

In some embodiments, these expressions are converted to tags. In practice, many documents may be associated with tags but may not be associated with a tag representing a highly relevant expression identified in step 718. In this case, the method is capable of extracting expressions and scoring the expression as if the expression were a tag in a manner similar to that described in connection with step 714. In some embodiments, the output of step 718 comprises a tuple (or similar data structure) representing the document, expression, and relevancy score.

In step 722, the method extracts relevant documents from the semantic document models.

In some embodiments, the method utilizes an indexed store of the corpus of documents in order to extract relevant documents. In some embodiments, this indexed store indexes the corpus of documents by tags. In some embodiments, the method extracts the tags from the target document and retrieves the documents associated with the tags.

In some embodiments, the method utilizes user details to identify and extract relevant documents. In general, the method utilizes details of the documents and the user details to recommend documents that are similar to those that a user has previously showed interest (e.g., bookmarked, searched for, etc.) and are unlike to the ones the user showed disinterest (e.g., is associated with a low click-through rate). That is, at a high level, various candidate documents are compared with documents previously interacted by the user and the best-matching documents are suggested.

Current techniques for identifying relevant documents to a user based on a user profile are based on blindly learning what the user likes, such as by using decision trees or neural networks. However, these methods require a large amount of training data and are hard to fine-tune to specifications, making them ideal where the domain is somewhat generic and significant behavioral data is available.

In contrast, in some embodiments, the method utilizes a weighted vector of features, where the weights denote the importance of each feature to the user and are computed using a variety of techniques. Some of these weights are exposed to system administrators, such as the importance of each interaction type. Other weights were adjusted through manual fine-tuning (e.g. according to the cyclical feedback) or through more sophisticated methods such as grid-search). This estimation method allows for very specific fine-tuning, a needed feature due to how a domain will already understood by system administrators. In some embodiments, a grid-search algorithm receives a scoring function and a set of candidate models and generates a best set of parameters for the models by searching a hyperspace of the set of parameters that the input models have and selecting the set of parameters that optimize the scoring function.

In step 724, the method scores similar documents using the extracted relevant documents and the extracted corpus expressions.

In one embodiment, a similar score represents the similarity of the target document text to the text of the relevant documents. As illustrated above, the preceding steps allow for a large corpus of documents to be refined to a smaller subset of documents thus allowing for the identification of similar documents based on the text of the documents. In some embodiments, the similarity of the text of documents is calculated using tf-idf vectors or similar metrics. In some embodiments, the method creates a vector that stores the similarity of a target document to one or more relevant documents. In some embodiments, the method sorts the relevant documents according to the relevancy scores of the documents.

In some embodiments, the method may score the documents based on the weighted sum of two functions. In some embodiments, a first function may calculate the similarity between a candidate document and the target document (e.g., the number of relevant tags in common in both documents weighted by the relevancies of each tag/document pair). A second function may calculate the similarity between the relevant chunking expressions of the candidate document and the relevant chunking expressions of the target document (e.g., which is to say that it is the number of relevant chunks in common in both documents weighted by the relevancies of each expression/document pair).

As discussed above, in some embodiments, the method may utilize user details to provide similar documents to a requesting user in response to a target document. In some embodiments, the method utilizes the user profile to determine how similar each similar document is as compared to documents that the user has previously showed interest in, and how dissimilar it is to documents the user has previously showed a disinterest in. In some embodiments, this includes giving more importance to documents where the user showed more interest (e.g. by giving it more views, likes, etc.) and adjusting the score based on this interest. In some embodiments, each interaction type (e.g., view, like, etc.) has its own score function and is dependent on its date attribute (i.e., the older the interaction, the less it is worth).

In a second embodiment, the method may utilize user interest to determine the ranking of the similar documents. In this embodiment, the method utilizes various user profile data (e.g., user preferences, created or liked tags, favorite document sources, etc.) to rank the similar documents. This embodiment may be utilized when a user has exhibited few interactions with documents and thus the previous embodiment may yield minimally useful results. In some embodiments, an interest score is calculated using a series of formulas and weights that were refined using grid-search.

In a third embodiment, the method may allow for override by a system administrator, thus allowing an administrator to manually re-rank documents according to one or more rules defined by the administrator. For example, an administrator may manually rank certain tags for certain users higher than other tags. In some embodiments, each of the three embodiments disclosed above may be used simultaneously.

In step 726, the method provides similar documents.

In some embodiments, the method is configured to package the relevant documents into an ordered list of documents, wherein each document is associated with a relevancy score (e.g., based on the tag-computed relevancy score and/or the similarity score) and an explanation of why each document is relevant to the target document. In some embodiments, the method is configured to transmit this listing of documents to an end user for display.

FIG. 8 is a block diagram illustrating a system for identifying documents related to a target document according to some embodiments of the disclosure.

In the illustrated embodiment, the system (800) may perform the functions described in connection with FIG. 7 and complete disclosure of the steps discussed in connection with FIG. 7 are not repeated herein for the sake of clarity.

In the illustrated embodiment, a user may transmit one or more target documents (802) to an application server (804). In some embodiments, a target document may be submitted to an application server (804) via a web page, desktop application, mobile application, or other graphical user interface allowing for the upload of documents from a client device to application server (804). Although illustrated as a single device, multiple application servers (804) may be utilized to increase the throughput of the system (800). Additionally one or more load balancers may be utilized to increase the throughput of the system.

Application server (804) additionally transmits recommended documents (818) to a client device (e.g., the client device transmitting the target document(s) (802)). In order to obtain the related documents (818), the application server transmits the target document(s) (802) to subsystem (820), described in more detail herein. In some embodiments, subsystem (820) may be located remotely from application server(s) (804). For example, application servers (804) can be located geographically throughout a region (or the world) whereas subsystem (820) may be deployed in a single location.

Semantic document model generator (806) receives a target document and generates semantic models for the target document and a plurality of documents stored in document corpus (802). In some embodiments, document corpus (802) and semantic model storage (808) may each comprise a relational database or other storage mechanism. Although illustrated as a single device, semantic document model generator (806) can comprise any number of server devices. Indeed, in many scenarios, the number of semantic document model generators (806) may be increase to increase system capacity by increasing the number of parallel computing jobs. In some embodiments, a semantic document model generator (806) comprises a virtual machine or process that may be instantiated on an as needed basis. For example, the subsystem (820) may identify a number of documents from document corpus (802) and may initiate a corresponding number of virtual machines for processing each document. In this manner, the system matches the theoretical maximum number of computing devices to fully optimizing the modeling procedure. In some embodiments, an instance of a semantic document model generator (806) may be exclusively used for processing incoming target documents. Specific methods for generating a semantic document model are described more fully in connection with FIGS. 7 and, in particular, steps 706-712, the disclosure of which is incorporated herein by reference in its entirety.

Subsystem (820) additionally includes a tag scorer (810) and an expression chunker (812). In the illustrated embodiment, these components may perform the methods described in connection with FIG. 7 and, in particular, steps 716-720, the disclosure of which is incorporated herein by reference in its entirety.

Subsystem (820) additionally includes a document filter (814). In the illustrated embodiment, this component extracts relevant documents from the semantic document models as described more fully in connection with step 724 of Figure, the disclosure of which is incorporated by reference.

Subsystem (820) additionally includes user profile database (816). As described in connection with FIG. 7, user profile data may be used to refine the documents filtered by document filter (814), additionally document filter (814) may transmit user profile data downstream to document score (816) for further scoring. In some embodiments, user profile database 716 comprises a relational database or similar data storage mechanism. In some embodiments, user profile data is collected by application server (804) during user interactions with a web site or other application provided by application server (804).

Subsystem (820) additionally includes a document score (816). In the illustrated embodiment, document score (816) performs the methods described in connection with FIG. 7 and, in particular, steps 726-728, the disclosure of which is incorporated herein by reference in its entirety. Document scorer (816) is additionally configured to return the related document (818) to application server (804) for transmission to a client device.

As with semantic document model generator (806), tag scorer (810), expression chunker (812), document filter (814), and document score (816) may include multiple computing devices or virtualized devices that are instantiated as needed and per-document or per-tag.

As described herein, the various methods disclosed may implemented in a variety of programming languages such as Java, Python, C#, C++, C, R, or any other suitable programming language. In some embodiments, Python or R may be preferred due to the abundance of machine learning “toolkits” available. Similarly, Scala (a Java derivative) may be preferred in other scenarios. In many implementations, the choice of language may be heterogeneous based on the speed requirements of various processing stages.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

The subject matter described above may be embodied in a variety of different forms and, therefore, the application/description intends for covered or claimed subject matter to be construed as not being limited to any example embodiments set forth herein; example embodiments are provided merely to be illustrative. Likewise, the application/description intends a reasonably broad scope for claimed or covered subject matter. Among other things, for example, subject matter may be embodied as methods, devices, components, or systems. Accordingly, embodiments may, for example, take the form of hardware, software, firmware or any combination thereof (other than software per se). The description presented above is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. The application/description intends, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium that can be used to tangibly store the desired information or data or instructions and that can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Wi-Fi, Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application that receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving a set of training documents;
parsing the set of training documents to generate a parsed set of training documents;
generating a semantic word model for the parsed set of training documents;
generating a semantic topic model for the parsed set of training documents;
creating a statistical classification model using the semantic word model and semantic topic model;
retrieving a set of related expressions;
creating an n-gram statistical model based on the related expressions, the semantic word model, and the semantic topic model;
receiving a target document; and
generating a set of suggested tags for the target document based on the statistical classification model and n-gram statistical model.

2. The method of claim 1, the parsing the set of training documents to generate a parsed set of training documents further comprising extracting textual and formatting content from a the set of training documents.

3. The method of claim 1, the generating a semantic word model performed using one of a word2vec algorithm or topic modeling algorithm.

4. The method of claim 1, the statistical classification model generated using a keyword model generator.

5. The method of claim 1, the set of suggested tags including a relevancy level and explanation for each suggested tag.

6. A method comprising:
receiving a set of documents;
generating a first set of suggested tags for the set of documents using a lexico-statistical model;
generating a second set of suggested tags for the set of documents using a dictionary-based model;
generating a third set of suggested tags for the set of documents using a topic modeling model;
combining the first, second, and third set of suggested tags into a combined set of suggested tags; and
transmitting the combined set of suggested tags to a client device.

7. The method of claim 6, further comprising filtering the combined set of suggested tags by removing a plurality of tags in the combined set of suggested tags, the plurality of tags being present within a tag hierarchy.

8. The method of claim 6, the lexico-statistical model generated using latent semantic indexing

9. The method of claim 6, the generating a second set of suggested tags for the set of documents using a dictionary-based model further comprising retrieving a set of dictionaries and calculating an n-gram similarity measurement between the set of documents and the set of dictionaries.

10. The method of claim 6, the generating a third set of suggested tags for the set of documents using a topic modeling model further comprising:
extracting candidate expressions from the set of documents; and
matching the candidate expressions with a predefined set of sources;

11. The method of claim 10, the extracting candidate expressions from the set of documents performed using a Latent Dirichlet Allocation model.

12. A method comprising:
receiving a document;
creating a semantic document model for the received document and a plurality of semantic document models for a corpus of documents;
scoring the plurality of semantic document models and the semantic document model;
identifying a set of overlapping tags associated with the received document and the corpus of documents;
retrieving a set of related documents based on the set of overlapping tags;
extracting relevant expressions by chunking the corpus of documents and the received document;
scoring the set of related documents based on the relevant expressions using a similarity scoring function; and
generating a listing of similar documents based on the scoring of the set of related documents and the scoring of the plurality of semantic document models and the semantic document model.

13. The method of claim 12, further comprising parsing the received document and documents in the corpus of documents, the parsing a document comprising extracting textual and formatting content of a document.

14. The method of claim 12, the creating a semantic document model performed using a Doc2Vec algorithm.

15. The method of claim 12 wherein scoring a semantic document model comprises determining a relevancy of a tag associated with a document associated with the semantic document model to a vector space associated with the semantic document model.

16. The method of claim 15, the scoring the set of related documents based on the relevant expressions using a similarity scoring function comprising:
calculating a first value representing a similarity between the related documents and the received document based on a number of tags in common and weighted by the semantic document models;
calculating a second value representing a similarity between the relevant expressions of the related documents and the received document; and
weighting a sum of the first and second values.

17. An apparatus comprising:
a processor; and
a storage medium for tangibly storing thereon program logic for execution by the processor, the stored program logic comprising:
logic, executed by the processor, for receiving a set of training documents,
logic, executed by the processor, for parsing the set of training documents to generate a parsed set of training documents,
logic, executed by the processor, for generating a semantic word model for the parsed set of training documents,
logic, executed by the processor, for generating a semantic topic model for the parsed set of training documents,
logic, executed by the processor, for creating a statistical classification model using the semantic word model and semantic topic model,
logic, executed by the processor, for retrieving a set of related expressions,
logic, executed by the processor, for creating an n-gram statistical model based on the related expressions, the semantic word model, and the semantic topic model,
logic, executed by the processor, for receiving a target document, and
logic, executed by the processor, for generating a set of suggested tags for the target document based on the statistical classification model and n-gram statistical model.

18. The apparatus of claim 17, the logic for parsing the set of training documents to generate a parsed set of training documents comprising logic, executed by the processor, for extracting textual and formatting content from a the set of training documents.

19. The apparatus of claim 17, the logic for generating a semantic word model performed using one of a word2vec algorithm or topic modeling algorithm.

20. The apparatus of claim 17, the statistical classification model generated using a keyword model generator.

21. The apparatus of claim 17, the set of suggested tags including a relevancy level and explanation for each suggested tag.

22. An apparatus comprising:
a processor; and
a storage medium for tangibly storing thereon program logic for execution by the processor, the stored program logic comprising:
logic, executed by the processor, for receiving a set of documents,
logic, executed by the processor, for generating a first set of suggested tags for the set of documents using a lexico-statistical model,
logic, executed by the processor, for generating a second set of suggested tags for the set of documents using a dictionary-based model,
logic, executed by the processor, for generating a third set of suggested tags for the set of documents using a topic modeling model,
logic, executed by the processor, for combining the first, second, and third set of suggested tags into a combined set of suggested tags, and
logic, executed by the processor, for transmitting the combined set of suggested tags to a client device.

23. The apparatus of claim 22, the logic further comprising logic, executed by the processor, for filtering the combined set of suggested tags by removing a plurality of tags in the combined set of suggested tags, the plurality of tags being present within a tag hierarchy.

24. The apparatus of claim 22 the lexico-statistical model generated using latent semantic indexing.

25. The apparatus of claim 22 wherein generating a second set of suggested tags for the set of documents using a dictionary-based model comprises retrieving a set of dictionaries and calculating an n-gram similarity measurement between the set of documents and the set of dictionaries.

26. The apparatus of claim 22, the logic for generating a third set of suggested tags for the set of documents using a topic modeling model further comprising:
logic, executed by the processor, for extracting candidate expressions from the set of documents; and
logic, executed by the processor, for matching the candidate expressions with a predefined set of sources.

27. The apparatus of claim 26, the logic for extracting candidate expressions from the set of documents performed using a Latent Dirichlet Allocation model.

28. An apparatus comprising:
a processor; and
a storage medium for tangibly storing thereon program logic for execution by the processor, the stored program logic comprising:
logic, executed by the processor, for receiving a document,
logic, executed by the processor, for creating a semantic document model for the received document and a plurality of semantic document models for a corpus of documents,
logic, executed by the processor, for scoring the plurality of semantic document models and the semantic document model,
logic, executed by the processor, for identifying a set of overlapping tags associated with the received document and the corpus of documents,
logic, executed by the processor, for retrieving a set of related documents based on the set of overlapping tags,
logic, executed by the processor, for extracting relevant expressions by chunking the corpus of documents and the received document,
logic, executed by the processor, for scoring the set of related documents based on the relevant expressions using a similarity scoring function, and
logic, executed by the processor, for generating a listing of similar documents based on the scoring of the set of related documents and the scoring of the plurality of semantic document models and the semantic document model.

29. The apparatus of claim 28, the logic further comprising logic, executed by the processor, for parsing the received document and documents in the corpus of documents, the parsing a document comprising extracting textual and formatting content of a document.

30. The apparatus of claim 28, the logic for creating a semantic document model is performed using a Doc2Vec algorithm.

31. The apparatus of claim 28, the logic for scoring a semantic document model further comprising logic, executed by the processor, for determining a relevancy of a tag associated with a document associated with the semantic document model to a vector space associated with the semantic document model.

32. The apparatus of claim 31, wherein the logic for scoring the set of related documents based on the relevant expressions using a similarity scoring function comprises:
logic, executed by the processor, for calculating a first value representing a similarity between the related documents and the received document based on a number of tags in common and weighted by the semantic document models;
logic, executed by the processor, for calculating a second value representing a similarity between the relevant expressions of the related documents and the received document; and
logic, executed by the processor, for weighting a sum of the first and second values.
